(19) United States
(12) Patent Application Publication
(10) Pub. No.: US 2025/0356326 A1
(43) Pub. Date: Nov. 20, 2025

(54) GOLD-BACKED CRYPTOCURRENCY

(71) Applicant: US Gold Currency, Inc., Jackson, WY (US)

(72) Inventors: Lawrence S. Debry, Dulles, GA (US); J. Martin Tate, Salt Lake City, UT (US)

(21) Appl. No.: 19/213,948

(22) Filed: May 20, 2025

Related U.S. Application Data
(60) Provisional application No. 63/649,542, filed on May 20, 2024.

(51) Int. Cl. G06Q 20/06; G06Q 20/36; G06Q 40/04

(52) U.S. Cl. CPC G06Q 20/06; G06Q 20/36; G06Q 40/04; G06Q 2220/00

(57) ABSTRACT

Disclosed herein is a digital cryptocurrency system, method, and program process. The digital cryptocurrency system includes a digital gold token and a physical gold coin digitally linked to the digital gold token. Also disclosed is a method of purchasing and exchanging digital currency including purchasing, by a token holder, a digital gold token, purchasing, by a trust administration, a physical gold coin, digitally linking the physical gold coin with the digital gold token, and physically storing the physical gold coin. A program product enables performance of operations such as purchasing a digital gold token on behalf of a token holder, purchasing a physical gold coin on behalf of a trust administration, and digitally linking the physical gold coin with the digital gold token.

### CROSS-REFERENCE TO RELATED APPLICATION

This application claims the benefit of U.S. Provisional Patent Application No. 63/649,542, filed May 20, 2024, which is incorporated herein by reference in its entirety.

### FIELD

The present disclosure relates generally to cryptocurrency and more particularly to cryptocurrency exchanges for real-world transactions.

### BACKGROUND

Cryptocurrency is a digital currency created using encryption algorithms. Unlike traditional currencies, digital currencies have no central issuing or regulating authorities to determine the value of the currency. As such, their value is highly volatile and may not be accepted globally for the sale and purchase of assets.

### SUMMARY

The subject matter of the present disclosure has been developed in response to the present state of the art, and in particular, in response to the problems and needs in the art that have not yet been fully solved by currently available cryptocurrency and associated exchanges. From the foregoing discussion, it should be apparent that a need exists for an apparatus, a system, and a method that more effectively value and reduce volatility of cryptocurrency. Beneficially, such an apparatus, system, and method would reduce drastic changes in value of cryptocurrency. Accordingly, the subject matter of the present disclosure has been developed to provide a cryptocurrency, backed by gold, that may overcome many or all of the above-discussed or other shortcomings in the art.

Disclosed herein is a digital cryptocurrency system. The digital cryptocurrency system includes a digital gold token and a physical gold coin digitally linked to the digital gold token. The preceding subject matter of this paragraph characterizes example 1 of the present disclosure.

The physical gold coin is a one-ounce American Eagle gold coin. The preceding subject matter of this paragraph characterizes example 2 of the present disclosure, wherein example 2 also includes the subject matter according to example 1, above.

The physical gold coin is a gold and metal alloy composite coin. The preceding subject matter of this paragraph characterizes example 3 of the present disclosure, wherein example 3 also includes the subject matter according to any of examples 1-2, above.

The digital cryptocurrency system further includes a vault. The physical gold coin is stored in the vault. The preceding subject matter of this paragraph characterizes example 4 of the present disclosure, wherein example 4 also includes the subject matter according to any of examples 1-3, above.

The digital gold token and the physical gold coin are digitally linked via a blockchain protocol. The preceding subject matter of this paragraph characterizes example 5 of the present disclosure, wherein example 5 also includes the subject matter according to any of examples 1-4, above.

The digital gold token and the physical gold coin are digitally linked via an Ethereum blockchain protocol. The preceding subject matter of this paragraph characterizes example 6 of the present disclosure, wherein example 6 also includes the subject matter according to any of examples 1-5, above.

The digital cryptocurrency system further includes a digital wallet. The digital gold token is stored in the digital wallet. The preceding subject matter of this paragraph characterizes example 7 of the present disclosure, wherein example 7 also includes the subject matter according to any of examples 1-6, above.

The digital wallet utilizes an Ethereum blockchain protocol. The preceding subject matter of this paragraph characterizes example 8 of the present disclosure, wherein example 8 also includes the subject matter according to any of examples 1-7, above.

Further disclosed herein is a method of purchasing and exchanging digital currency. The method includes purchasing, by a token holder, a digital gold token, purchasing, by a trust administration, a physical gold coin, digitally linking the physical gold coin with the digital gold token, and physically storing the physical gold coin. The preceding subject matter of this paragraph characterizes example 9 of the present disclosure.

The method further includes requesting, by the token holder, the digital gold token be redeemed for the physical gold coin, and physically sending the physical gold coin to the token holder in exchange for the digital gold token. The preceding subject matter of this paragraph characterizes example 10 of the present disclosure, wherein example 10 also includes the subject matter according to example 9, above.

The physical gold coin is a one-ounce American Eagle coin. The preceding subject matter of this paragraph characterizes example 11 of the present disclosure, wherein example 11 also includes the subject matter according to any of examples 9-10, above.

The digital gold token and the physical gold coin are digitally linked via a blockchain protocol. The preceding subject matter of this paragraph characterizes example 12 of the present disclosure, wherein example 12 also includes the subject matter according to any of examples 9-11, above.

The digital gold token and the physical gold coin are digitally linked via an Ethereum blockchain protocol. The preceding subject matter of this paragraph characterizes example 13 of the present disclosure, wherein example 13 also includes the subject matter according to example 12, above.

Linking the physical gold coin with the digital gold token further comprises storing the digital gold token in a digital wallet. The preceding subject matter of this paragraph characterizes example 14 of the present disclosure, wherein example 14 also includes the subject matter according to any of examples 9-13, above.

The digital wallet stores the digital gold token via an Ethereum blockchain protocol. The preceding subject matter of this paragraph characterizes example 15 of the present disclosure, wherein example 15 also includes the subject matter according to example 14, above.

The physical gold coin is stored in a vault. The preceding subject matter of this paragraph characterizes example 16 of the present disclosure, wherein example 16 also includes the subject matter according to any of examples 9-15, above.

Additionally disclosed here in a program product including a non-transitory computer readable storage medium storing code, the code being configured to be executable by a processor to perform operations including purchasing a digital gold token on behalf of a token holder, purchasing a physical gold coin on behalf of a trust administration, and digitally linking the physical gold coin with the digital gold token. The preceding subject matter of this paragraph characterizes example 17 of the present disclosure.

The digital gold token and the physical gold coin are digitally linked via a blockchain protocol. The preceding subject matter of this paragraph characterizes example 18 of the present disclosure, wherein example 18 also includes the subject matter according to example 17, above.

The digital gold token and the physical gold coin are digitally linked via an Ethereum blockchain protocol. The preceding subject matter of this paragraph characterizes example 19 of the present disclosure, wherein example 19 also includes the subject matter according to example 18, above.

The code is further configured to be executable by the processor to perform operations including receiving a request, by the token holder, to redeem the digital gold token for the physical gold coin, alerting the trust administration of the request for redemption of the physical gold coin, and tracking the exchange of the digital gold token for the physical gold coin to the token holder. The preceding subject matter of this paragraph characterizes example 20 of the present disclosure, wherein example 20 also includes the subject matter according to any of examples 17-19, above.

According to one example of the present disclosure, a digital currency system includes a digital cryptocurrency (e.g., digital gold token) and a physical gold coin tied to, or backing, the cryptocurrency. The cryptocurrency has a one-to-one exchange ratio to the physical gold coin. In some examples, the physical gold coin is stored in a state-of-the-art, fully-insured vault. In another example, the physical gold coin is stored by a traditional bank in the bank's vault. In some examples, the digital cryptocurrency leverages a blockchain protocol. In yet another example, the blockchain protocol leveraged by the cryptocurrency is an Ethereum protocol.

In another example of the present disclosure, a method of exchanging a digital currency backed by gold is described herein. The method includes purchasing digital gold tokens, purchasing physical gold coins in a quantity corresponding with the digital gold tokens, physically storing the physical gold coins, digitally storing the digital gold tokens for purchasing and selling assets, exchanging digital gold tokens for gold coins, and distributing gold coins to purchaser.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter of the present disclosure will be readily understood, a more particular description of the subject matter briefly described above will be rendered by reference to specific embodiments that are illustrated in the appended drawings. Understanding that these drawings depict only typical embodiments of the subject matter of the present disclosure and are not therefore to be considered to be limiting of its scope, the subject matter will be described and explained with additional specificity and detail through the use of the accompanying drawings, in which:

FIG. 1 is schematic flow diagram of a method of exchanging a digital currency backed by gold, according to one or more examples of the present disclosure;

FIG. 2 is a schematic block diagram illustrating a system for a digital currency backed by gold, according to one or more examples of the present disclosure;

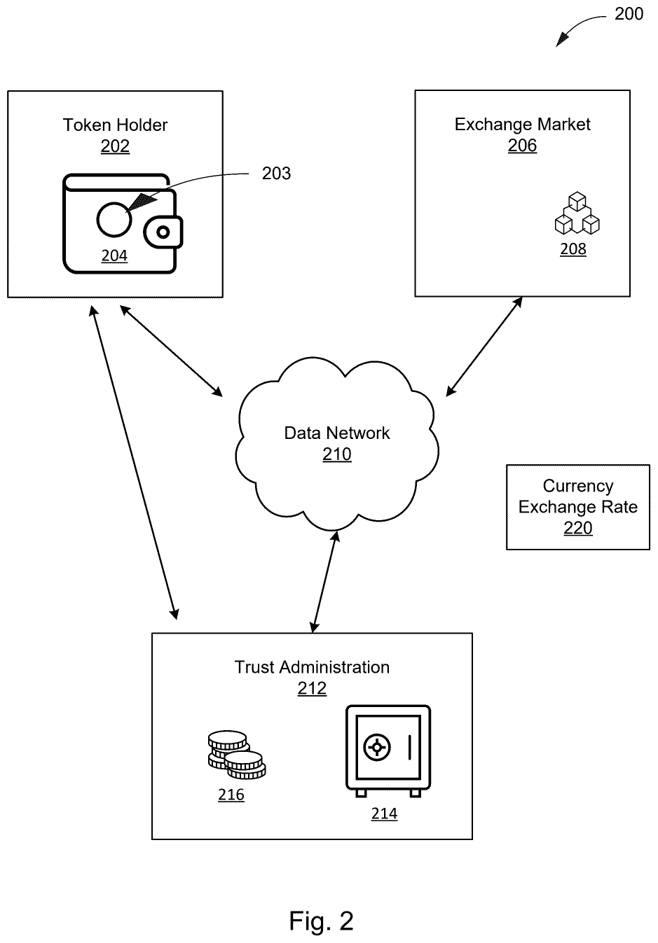

FIG. 3 is a schematic flow diagram of a gold-backed cryptocurrency purchase process, according to one or more examples of the present disclosure; and

FIG. 4 is a schematic flow diagram of a gold-backed cryptocurrency redemption process, according to one or more examples of the present disclosure.

### DETAILED DESCRIPTION

Reference throughout this specification to “one example,” “an example,” or similar language means that a particular feature, structure, or characteristic described in connection with the example is included in at least one example of the subject matter of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more embodiments of the subject matter of the present disclosure, however, absent an express correlation to indicate otherwise, an implementation may be associated with one or more examples.

According to one example, a digital currency system 200 includes a digital cryptocurrency (i.e., digital gold token 203). The cryptocurrency has a one-to-one exchange ratio with or is linked to a physical gold coin 216 (or other physical gold asset). In one example, the physical gold coin 216 is an American Eagle gold coin, which is a gold coin produced by the U.S. Mint. The price of these gold coins is set by the U.S. Mint and experiences generally infrequent fluctuations or minor fluctuations, thus providing a relatively stable monetary value. In another example, the physical gold coin 216 is not created and sold by a governmental entity, but by an independent third party. The independent third party can sell the physical gold coin 216 based upon a gold-to-alloy ratio, so that the value of the physical gold coin 216 is based on current gold prices.

In some examples, the physical gold coin 216 is stored in a vault 214, which can be a state-of-the-art and fully-insured vault. In another example, the physical gold coin 216 is stored by a traditional bank in the bank's vault. In one example, the physical gold coin 216 is stored by a trust, or trust administration 212, that will hold the physical gold coins 216 for the benefit of token holders 202 who hold digital gold tokens 203.

In some examples, the digital cryptocurrency (e.g., digital gold tokens 203) leverages blockchain 208. A blockchain 208 is a distributed database or ledger identifying various past transactions of a particular asset, such as financial transactions. A blockchain 208 is an immutable and uneditable digital chain storing information. Once a block is formed within a chain, it cannot be changed by another user. Instead, new blocks are created and added to the chain when a new transaction takes place. In one example, blockchain 208 is permission based, such that only the authorized parties may access the blockchain 208. In another example, the blockchain 208 is public and available to be viewed by any party.

In yet another example, the blockchain 208 leveraged by the cryptocurrency utilizes the Ethereum protocol. In another example, the blockchain 208 leveraged by the cryptocurrency utilizes the Hyperledger protocol. Alternatively, the blockchain 208 leveraged by the cryptocurrency utilizes Quorum protocol. A blockchain may be leveraged by any number of protocols, such as the ones identified above or any other suitable protocols.

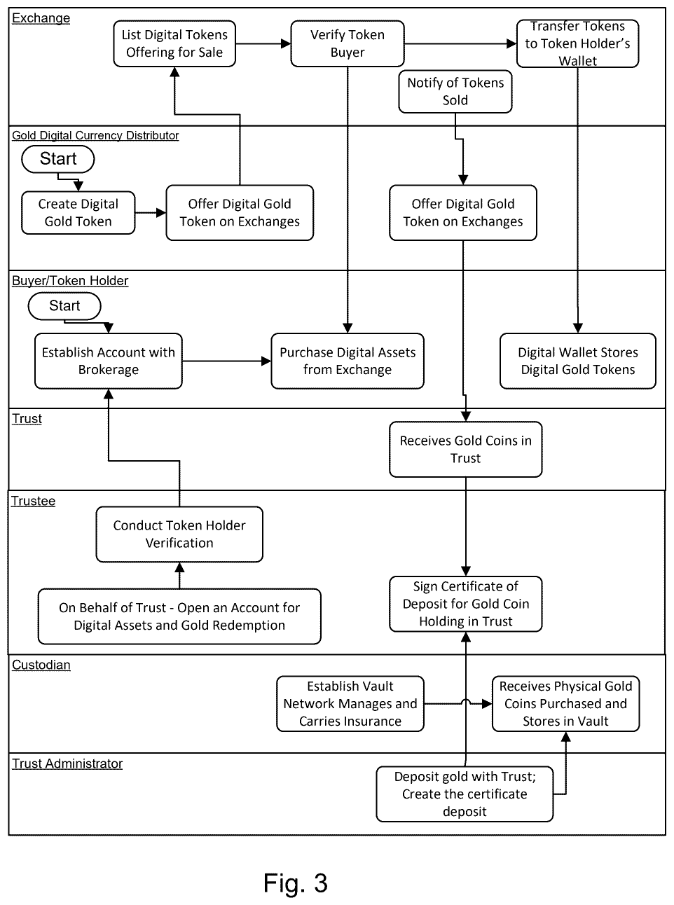

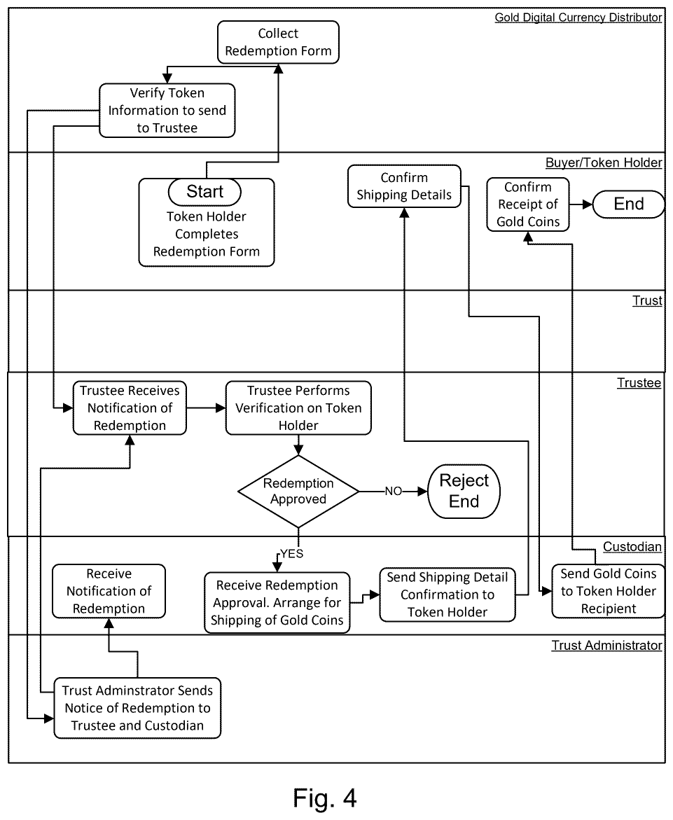

In one example, the token holder 202 has a digital wallet 204 configured to store one or more digital gold tokens 203. The token holder 202 may purchase assets with the digital gold token 203 stored within their wallet 204. The digital gold token 203 is backed by one or more physical gold coins 216 equivalent to the value of the digital gold token 203. The token holder 202 can purchase one or more digital gold tokens 203 using the process identified in FIG. 3. The token holder 202 may exchange the digital gold token 203 for the physical gold coin 216 tied to or backing the digital gold token 203. In one example, the token holder 202 can exchange or redeem the digital gold token 203 for the physical gold coin 216 using the process identified in FIG. 4. In one example, the digital wallet 204 is digitally accessed using a web-based platform. In another example, the digital wallet 204 is combination of a web-based platform and a physical security key.

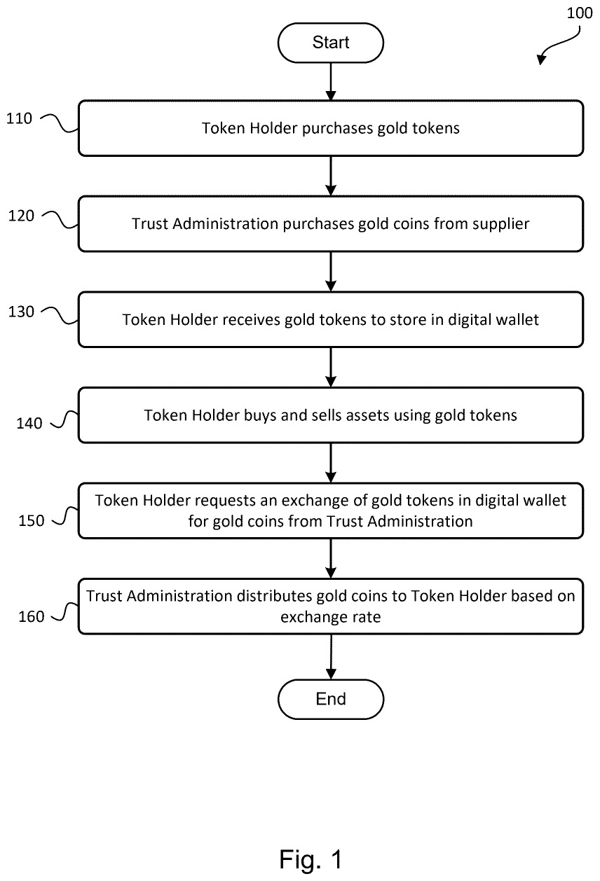

As shown in FIG. 1, a method 100 of purchasing and exchanging a digital currency (e.g., digital gold token) backed by gold is shown. The method 100 generally includes purchasing digital gold tokens, purchasing gold coins proportional to the digital gold tokens, physically storing the physical gold coins, digitally coupling the digital gold tokens to the physical gold coins, digitally storing the digital gold tokens to be used to purchase and sell assets, redeeming the digital gold tokens for physical gold coins, and the distribution of physical gold coins to the purchaser of the digital gold tokens. As used herein, a physical gold coin can be a physical coin made of gold or a gold alloy or any physical object made of gold or a gold alloy. Additionally, as used herein, gold or gold alloy can be any of various precious metals, such as silver or silver alloys, platinum or platinum alloys, palladium or palladium alloys, or any other of various precious metals.

The method 100 begins with step 110, in which a token holder 202 purchases gold tokens 203. In one example, the digital gold tokens 203 are purchased from a third-party distributor. In alternative examples, the digital gold tokens 203 are purchased directly from a trust administration 212. In step 120, the trust administration 212 purchases gold coins 216 and links the physical gold coins 216 to the digital gold tokens 203 purchased at step 110, such as in a one-to-one ratio. The purchase of gold coins 216, to back the digital gold tokens 203, is based on the applicable currency exchange rate 220. In one example, the digital gold token 203 has a one-to-one correlation to American Eagle gold coins which has a corresponding value in U.S. dollars. The value of the physical gold coin 216, and thus the value of the digital gold token 203, may be determined using any currency, including Swiss Francs, Euros, and Yen, to name a few. Exchange rates are determined by the worldwide currency exchange rates, which may change daily. The value of the digital gold token 203 may be determined by third-parties according to any number of factors and may fluctuate at any given time.

As identified in step 130, the digital gold token 203 is received by the token holder 202 and stored in the token holder's digital wallet 204. A digital wallet 204 may be any form of cryptocurrency storage. In one example, the digital wallet 204 is an application on the token holder's mobile device. In another example, the digital wallet 204 is hosted on a third-party website and accessible through any network connected device.

The token holder 202 has the ability to purchase and sell various assets using the digital gold token 203 stored in the token holder's digital wallet 204, as identified in step 140. Step 140 is an optional step, in one example the token holder 202 sells an asset in exchange for a gold token(s) 203, which is then added to the digital wallet 204. In another example, the token holder 202 uses the digital gold token 203 to purchase assets. In one example, the sale and purchase of assets takes place within the exchange market 206. Sales and purchases in the exchange market 206 can use blockchains 208 to identify the sales and purchases. The protocol of the blockchain 208, in one example, is Ethereum. In an alternative example, the protocol of the blockchain 208 is Quorum. The sales and purchases of assets may include any number of assets such as an NFT, the purchase or sale of intellectual property rights, the purchase of a license, etc.

As identified in step 150, the token holder 202 requests an exchange or redemption of the digital gold token 203 in the digital wallet 204 for the physical gold coin 216 from the trust administration 212. The trust administration 212 exchanges the digital gold token 203 for the physical gold coin 216 in response to the request. The trust administration 212 then distributes the physical gold coin 216 to the token holder 202, as identified in step 160.

In the system 200, the data network 210 facilitates the interaction between members of the system. In one example, the data network 210 may be the internet and/or a mobile telephone network. The data network 210 may also employ a Wi-Fi network. Alternatively, the data network 210 may be a BLUETOOTH® connection and/or employ a Radio Frequency Identification (“RFID”) communication.

FIG. 3 illustrates a schematic flow diagram of a gold-backed cryptocurrency purchase process. In one example, the flow diagram is sectioned based on the party and their respective actions. The respective parties include, at least, an exchange 206, a gold digital currency distributor, a token holder 202 (e.g., buyer), a trust, a trustee, a custodian, and a trust administrator. The trust is typically created to hold purchased tokens in the trust for the benefit of the token holders 202. A custodian is a party who holds the physical gold coins 216 on behalf of the trust. In some examples, the custodian includes a vault or vault network and manages the corresponding insurance. The trust is administered by the trust administrator and is subject to the trustee.

In one example, the process begins with a gold digital currency distributor that creates a digital gold token 203. In connection with the creation of the digital gold token 203, a trustee conducts verification of the gold digital currency distributor. The verification conducted by the trustee may include Anti-Money Laundering (AML) and Know Your Customer (KYC) verification procedures. The trustee will also open an account on behalf of the trust with the custodian in connection with the verification of the gold digital currency distributor. The trustee is the holder of a custodial agreement with the custodians regarding the deposit and storage of the gold coins 216 and the transfer of gold coins 216 upon redemption by the token holder 202.

Returning to the creation of the digital gold token 203, once the gold token 203 is created, the gold digital currency distributor offers the digital gold token 203 on an exchange 206, thereby creating a listing of digital assets for sale in the exchange 206.

In some examples, either simultaneously or shortly thereafter the digital gold token 203 is created, the token holder 202 establishes an account with a brokerage from which the token holder 202 can purchase digital tokens 203 from the exchange 206. When a token holder 202 wishes to purchase the digital tokens 203 from the exchange 206 the exchange 206 conducts a verification of the token holder 202. Similar to the verification of the gold digital currency distributor, the token holder verification may include AML and KYC verification procedures. Upon purchase of the digital tokens, the exchange 206 notifies the gold digital currency distributor of the quantity of tokens 203 purchased and the purchased tokens are added to the token holder's wallet 204.

Upon notification of the quantity of tokens 203 purchased, the gold digital currency distributor correlates the digital tokens 203 to the quantity of gold coins 216 to be secured in the trust on behalf of the token holder 202. In some examples, the trust administrator is responsible for the deposit and transfer of gold coins 216 to the trust. The trust administrator also creates the certificate of deposit signed by the gold digital currency distributor and the trustee.

FIG. 4 illustrates a schematic flow diagram of a gold-backed cryptocurrency redemption process. The redemption process includes parties such as a gold digital currency distributor, a token holder 202 (buyer), a trust, a trustee, a custodian, and a trust administrator. The redemption process begins when the token holder 202 completes a redemption of gold tokens form, or other redemption notification method, for the gold digital currency distributor. The gold digital currency distributor receives the form identifying information to send to the trustee regarding redemption. The gold digital currency distributor also verifies the digital information corresponding to the gold tokens 203 to be redeemed. Upon verification, the identifying information and verification is sent to the trustee and trust administrator. The trust administrator sends a notice of redemption to the trustee and custodian. Upon receipt of a notice of redemption from the gold digital currency distributor and the trust administrator the trustee performs AML on the token holder. If the redemption is approved by the trustee, the custodian receives approval and arranges for the shipping and/or delivery of the physical gold coins 216 to the token holder 202. The token holder 202 may receive confirmation of shipping or delivery details prior to the distribution of physical gold coins 216. The token holder 202 may also be required to provide confirmation of receipt of the physical gold coins 216 from the custodian. If the redemption approval fails, the physical gold coins 216 are not distributed by the custodian and the process ends.

In one example, a program product may be used for a gold-backed cryptocurrency. The program product includes code configured to be executable by a processor to perform operations including purchasing a digital gold coin on behalf of a token holder; purchasing a physical gold coin on behalf of a trust administration, and digitally linking the physical gold coin with the digital gold token. In one example, the digital gold token and the physical gold coin are digitally linked via a blockchain protocol. In one example, the digital gold token and the physical gold coin are digitally linked via an Ethereum blockchain protocol.

In some examples, the program product operation include receiving a request, by the token holder, to redeem the digital gold token for the physical gold coin, alerting the trust administration of the request for redemption of the physical gold coin, and tracking the exchange of the digital gold token for the physical gold coin to the token holder.

Cryptocurrency, backed by physical gold coins, has increased security and stability compared to traditional digital currencies. Traditional digital currencies are based on trust and are highly volatile assets. The digital currency described herein provides a more stable asset, having real value based on the price of a physical gold coin, which may be exchanged at any time for global transactions.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Many of the functional units described in this specification can operate as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The described features, structures, or characteristics of the embodiments may be combined in any suitable manner. In the above description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A digital cryptocurrency system, comprising:
a digital gold token; and
a physical gold coin digitally linked to the digital gold token.

2. The digital cryptocurrency system of claim 1, wherein the physical gold coin is a one-ounce American Eagle gold coin.

3. The digital cryptocurrency system of claim 1, wherein the physical gold coin is a gold and metal alloy composite coin.

4. The digital cryptocurrency system of claim 1, further comprising a vault, wherein the physical gold coin is stored in the vault.

5. The digital cryptocurrency system of claim 1, wherein the digital gold token and the physical gold coin are digitally linked via a blockchain protocol.

6. The digital cryptocurrency system of claim 1, wherein the digital gold token and the physical gold coin are digitally linked via an Ethereum blockchain protocol.

7. The digital cryptocurrency system of claim 1, further comprising a digital wallet, wherein the digital gold token is stored in the digital wallet.

8. The digital cryptocurrency system of claim 1, wherein the digital wallet utilizes an Ethereum blockchain protocol.

9. A method of purchasing and exchanging digital currency comprising:
purchasing, by a token holder, a digital gold token;
purchasing, by a trust administration, a physical gold coin;
digitally linking the physical gold coin with the digital gold token; and
physically storing the physical gold coin.

10. The method of claim 9, further comprising:
requesting, by the token holder, the digital gold token be redeemed for the physical gold coin; and
physically sending the physical gold coin to the token holder in exchange for the digital gold token.

11. The method of claim 9, wherein the physical gold coin is a one-ounce American Eagle coin.

12. The method of claim 9, wherein the digital gold token and the physical gold coin are digitally linked via a blockchain protocol.

13. The method of claim 12, wherein the digital gold token and the physical gold coin are digitally linked via an Ethereum blockchain protocol.

14. The method of claim 9, wherein linking the physical gold coin with the digital gold token further comprises storing the digital gold token in a digital wallet.

15. The method of claim 14, wherein the digital wallet stores the digital gold token via an Ethereum blockchain protocol.

16. The method of claim 9, wherein the physical gold coin is stored in a vault.

17. A program product comprising a non-transitory computer readable storage medium storing code, the code being configured to be executable by a processor to perform operations comprising:
purchasing a digital gold token on behalf of a token holder;
purchasing a physical gold coin on behalf of a trust administration; and
digitally linking the physical gold coin with the digital gold token.

18. The program product of claim 17, wherein the digital gold token and the physical gold coin are digitally linked via a blockchain protocol.

19. The program product of claim 18, wherein the digital gold token and the physical gold coin are digitally linked via an Ethereum blockchain protocol.

20. The program product of claim 17, wherein the code is further configured to be executable by the processor to perform operations comprising:
receiving a request, by the token holder, to redeem the digital gold token for the physical gold coin;
alerting the trust administration of the request for redemption of the physical gold coin; and
tracking the exchange of the digital gold token for the physical gold coin to the token holder.
